(19) United States
(12) Patent Application Publication
(10) Pub. No.: US 2008/0037633 A1
(43) Pub. Date: Feb. 14, 2008

(54) Method and Device for Coding a Sequence of Video Images

(75) Inventors: Stephane Pateux, Saint-Gregoire (FR); Sylvain Kervadec, Rennes (FR); Isabelle Amonou, Thorigne Fouillard (FR)

Correspondence Address: LOWE HAUPTMAN HAM & BERNER, LLP, 1700 DIAGONAL ROAD, SUITE 300, ALEXANDRIA, VA, 22314, US

(73) Assignee: FRANCE TELECOM, Paris (FR)

(21) Appl. No.: 11/571,946

(22) PCT Filed: Jun. 28, 2005
(86) PCT No.: PCT/FR05/01639

§ 371 Date: Aug. 31, 2007

(30) Foreign Application Priority Data
Jul. 13, 2004 (FR) 04 07833

(51) Int. Cl. G06T 9/00

(52) U.S. Cl. 375/240.11; 375/E07.032

(57) ABSTRACT

A video image sequence is coded or decoded. By motion compensated temporal filtering, using discrete wavelet decomposition, the discrete wavelet is decomposed by dividing the video image sequence into source and destination groups of images. An image in the destination group is determined from at least one image including pixels in the first group of the source group. The representative image includes pixels and subpixels determined from pixels and subpixels obtained by upsampling at least one image in the source group.

### RELATED APPLICATIONS

The present application is based on, and claims priority from, France Application Number 04 07833, filed Jul. 13, 2004, and International Application No. PCT/FR05/01639 filed Jun. 28, 2005 the disclosure of which is hereby incorporated by reference herein in its entirety.

### FIELD OF THE INVENTION

The present invention concerns a method and device for coding and decoding a sequence of video images by motion-compensated temporal filtering using discrete wavelet decomposition.

More precisely, the present invention is situated in the field of the coding of a sequence of digital images using motion compensation and temporal transforms by discrete wavelet transformation.

### BACKGROUND OF THE INVENTION

Currently the majority of coders used for coding sequences of video images generate a single data stream corresponding to the entire coded sequence of video images. When a client wishes to use a coded sequence of video images, he must receive and process the entire coded sequence of video images.

However, in telecommunication networks such as the Internet, clients have different characteristics. These characteristics are for example, the bandwidth respectively allocated to them in the telecommunication network and/or the processing capacities of their telecommunication terminal. Moreover, clients, in some cases, wish initially to display the sequence of video images rapidly in a low resolution and/or quality, even if it means displaying it subsequently in optimum quality and resolution.

In order to mitigate these problems, so-called scalable video image sequence coding algorithms have appeared, that is to say with variable quality and/or spatio-temporal resolution, in which the data stream is coded in r several layers, each of these layers being nested in the higher-level layer. For example, part of a data stream comprising the sequence of video images coded with a lower quality and/or resolution is sent to the clients whose characteristics are limited, and the other part of the data stream comprising complementary data in terms of quality and/or resolution is sent solely to the client whose characteristics are high, without having to code the video image sequence differently.

More recently, algorithms using motion-compensated temporal filtering using discrete wavelet decomposition (in English “discrete wavelet transform” or DWT) have appeared. These algorithms first of all execute a wavelet temporal transform between the images of the video image sequence and then spatially decompose the resulting temporal sub-bands. More precisely, the video image sequence is decomposed into two groups of images, the even images and odd images, and a motion field is estimated between each even image and the closest odd image or images used during the wavelet temporal transformation. The even and odd images are motion compensated with respect to each other iteratively in order to obtain temporal sub-bands. The iteration of these groups creation and motion compensation process can be effected in order to generate various wavelet transformation levels. The temporal images are subsequently filtered spatially by means of wavelet analysis filters.

At the end of the decomposition the result is a set of spatio-temporal sub-bands. The motion field and the spatio-temporal sub-bands are finally coded and transmitted in layers corresponding to the resolution levels targeted. Some of these algorithms carry out the temporal filtering according to the technique presented in the publication by W Sweldens, Siam J. Anal., Vol 29, No 2, pp 511-546, 1997 and known by the English term “Lifting”.

Amongst these algorithms, it was proposed, in the publication entitled “3D sub band video coding using Barbell Lifting; MSRA Asia; Contribution S05 to the CFP Mpeg-21 SVC”, to update the pixels of the even images with pixels from the odd images using the weightings of the pixels of the odd images used during the prediction of the odd images from the even images, in order to effect a weighted updating using these weightings. A point P(x,y) of an even image contributing with a weight W to the prediction of a point Q′(x′,y′) of an odd image will be updated with a contribution of the weighted point Q′(x′,y′) of the weight w.

This solution is not satisfactory. This is because several problems are not resolved by this algorithm. There exist in the even images pixels which are not updated. This non-updating of pixels, referred to as holes, makes the updating of the motion field not perfectly reversible and causes artefacts when the image is reconstructed at the decoder of the client. In addition, for certain pixels updated by a plurality of pixels of an even image, the updating is not normalized. This absence of normalization also causes artefacts, such as pre- and/or post-echoes when the image is reconstructed at the decoder of the client.

The aim of the invention is to resolve the drawbacks of the prior art by proposing a method and device for coding and decoding a video image sequence by motion-compensated temporal filtering using discrete wavelet decomposition in which the images reconstructed at the decoder do not have the artefacts of the prior art.

### SUMMARY OF THE INVENTION

To this end, according to the first aspect, the invention proposes a method of coding a video image sequence by motion-compensated temporal filtering using discrete wavelet decomposition, a discrete wavelet decomposition comprising a step of dividing the video image sequence into two groups of images, at least one step of determining, from at least one image composed of pixels in one of the groups of images called the source group, an image representing an image of the other group of images called the destination group, characterised in that the representative image comprises pixels and subpixels determined from pixels and subpixels obtained by oversampling at least one image of the source group.

Correspondingly, the invention concerns a device for coding a video image sequence by motion-compensated temporal filtering using a discrete wavelet decomposition, the device comprising discrete wavelet decomposition means comprising means of dividing the video image sequence into two groups of images, means of determining, from at least one image composed of pixels in one of the groups of images called the source group, an image representing an image in the other group of images called the destination group, characterised in that the coding device comprises means for forming the representative image comprising pixels and subpixels determined from pixels obtained by means of upsampling at least one image in the source group.

Thus it is possible to carry out a coding of a video image sequence by motion-compensated temporal filtering using discrete wavelet decomposition that can make estimations of motion at subpixel level and thus make it possible to avoid, if the motion is contractive or expansive, the loss of information and the introduction of an “aliasing” phenomenon due to the change in resolution.

According to another aspect of the invention, the images in the source group are upsampled by performing at least one wavelet decomposition synthesis.

Thus, when the coding is carried out at a spatial sub-resolution, the wavelet synthesis is particularly well suited to upsampling, this being the inverse of a wavelet decomposition.

According to another aspect of the invention, a motion field is determined between the image in the source group and each image in the image destination group used for determining the image and, from the motion field determined, at least one pixel and/or subpixel of each image in the source group used for predicting the image is associated with each pixel and with each subpixel of the image representing the image in the destination group.

Thus the motion field is perfectly reversible, and no problem related to the holes of the prior art is liable to create artefacts during the decoding of the video image sequence.

According to another aspect of the invention, the value of each pixel and of each subpixel of the image representing the image in the destination group is obtained by summing the value of each pixel and subpixel associated with the subpixel and subpixel of the image representing the image in the destination group and by dividing the sum by the number of pixels and subpixels associated with the said pixel or subpixel of the image representing the image in the destination group.

Thus artefacts such as pre- and/or post-echo are greatly reduced when the video image sequence is decoded.

According to another aspect of the invention, the image representing the image in the destination group is filtered by a low-pass filter.

Thus the problems relating to contractive motions are reduced.

According to another aspect of the invention, the image representing the image in the destination group is subsampled using at least one discrete wavelet decomposition in order to obtain a subsampled image with the same resolution as the image in the destination group of images that it represents.

The present invention concerns also a method of decoding a video image sequence by motion-compensated temporal filtering using discrete wavelet decomposition, a discrete wavelet decomposition comprising a step of dividing the video image sequence into two groups of images, at least one step of determining, from at least one image composed of pixels in one of the groups of images called the source group, an image representing an image in the other group of images called the destination group, characterised in that the representative image comprises pixels and subpixels determined from pixels and subpixels obtained by upsampling at least one image in the source group.

Correspondingly, the invention concerns a device for decoding a video image sequence by a motion-compensated temporal filtering using discrete wavelet decomposition, the device comprising discrete wavelet decomposition means comprising means of dividing the video image sequence into two groups of images, means of determining, from at least one image composed of pixels in one of the groups of images called the source group, an image representing an image in the other group of images called the destination group, characterised in that the decoding device comprises means for forming the representative image comprising pixels and subpixels determined from pixels and subpixels obtained by means of upsampling at least one image in the source group.

The invention also concerns a signal comprising a video image sequence coded by motion-compensated temporal filtering using discrete wavelet decomposition, the signal comprising high- and low-frequency images obtained by dividing the video image sequence into two groups of images, and by determining, from at least one image composed of pixels in one of the groups of images called the source group, an image representing an image in the other group of images called the destination group, characterised in that the high- and low-frequency images are obtained from pixels and subpixels determined from pixels and subpixels obtained by upsampling at least one image in the source group.

The invention also concerns a method of transmitting a signal comprising a video image sequence coded by motion-compensated temporal filtering using discrete wavelet decomposition, characterised in that the signal comprises high- and low-frequency images obtained by dividing the video image sequence into two groups of images and determining, from at least one image composed of pixels in one of the groups of images called the source group, an image representing an image in the other group of images called the destination group, and in which the high- and low-frequency images are obtained from pixels and subpixels determined from pixels and subpixels obtained by upsampling at least one image in the source group.

The invention also concerns a method of storing a signal comprising a video image sequence coded by motion-compensated temporal filtering using discrete wavelet decomposition, characterised in that the signal comprises high- and low-frequency images obtained by dividing the video image sequence into two groups of images and determining, from at least one image composed of pixels in one of the groups of images called the source group, an image representing an image in the other group of images called the destination group, and in which the high- and low-frequency images are obtained from pixels and subpixels determined from pixels and subpixels obtained by upsampling at least one image in the source group.

The advantages of the method, of the decoding device and of the signal comprising the video image sequence transmitted and/or stored on a storage means being identical to the advantages of the coding method and device, these will not be repeated.

The invention also concerns the computer programs stored on an information medium, the said programs containing instructions for implementing the methods described above, when they are loaded into and executed by a computer system.

The characteristics of the invention mentioned above, as well as others, will emerge more clearly from a reading of the following description of an example embodiment, the said description being given in relation to the accompanying drawings, amongst which:

### BRIEF DESCRIPTION OF THE DRAWING

FIG. 1 is a block diagram of a video coder with motion-compensated temporal filtering;

FIG. 2 is a block diagram of the motion-compensated temporal filtering module of the video coder of FIG. 1 when Haar filters are used in the wavelet decomposition;

FIG. 3 is a block diagram of a computing and/or telecommunication device able to execute the coding and decoding algorithms in accordance with the algorithms described with reference to FIGS. 4 and 8;

FIG. 4 is a flow diagram of the coding algorithm executed by a processor when the motion-compensated temporal filtering is executed from software and in which Haar filters are used in the wavelet decomposition;

FIG. 5 is a block diagram of a video decoder with motion-compensated temporal filtering according to the invention;

FIG. 6 is a block diagram of the inverse motion compensated temporal filtering module of the video decoder of FIG. 5 when Haar filters are used in the wavelet decomposition;

FIG. 7 is a flow diagram of the decoding algorithm executed by a processor when the inverse motion-compensated temporal filtering is executed using software and in which Haar filters are used in the wavelet decomposition.

### DETAILED DESCRIPTION OF THE DRAWING

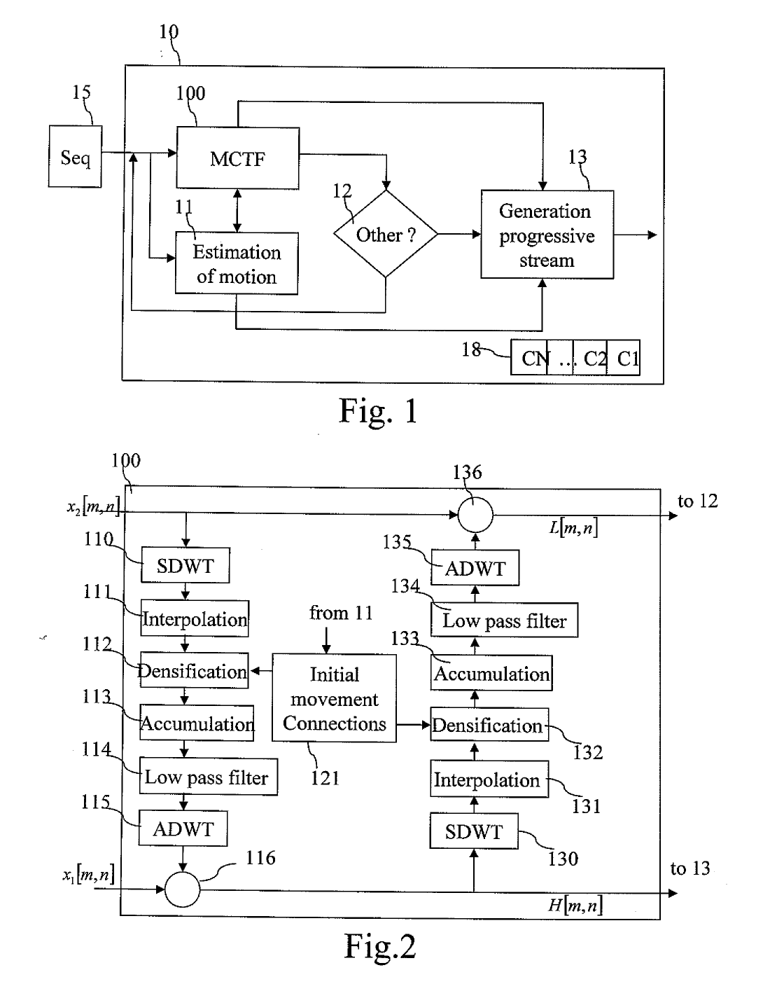

FIG. 1 depicts a block diagram of a video coder with motion compensated temporal filtering.

The video coder with motion compensated temporal filtering 10 is able to code a video image sequence 15 in a scalable data stream 18. A scalable data stream is a stream in which the data are arranged in such a way that it is possible to transmit a representation, in terms of resolution and/or in quality of the image, that is variable according to the type of application receiving the data. The data included in this scalable data stream are coded so as to ensure the transmission of video image sequences in a scaled manner or “scalable” in English terminology in terms of both quality and resolution without having to effect various codings of the video image sequence. It is thus possible to store on a data medium and/or to transmit only part of the scalable data stream 18 to a telecommunication terminal when the transmission rate of the telecommunication network is low and/or when the telecommunication terminal does not need high quality and/or resolution.

It is also possible to store on any data medium and/or to transmit the entire scalable data stream 18 to a telecommunication terminal when the transmission rate of the telecommunication network is high and the telecommunication terminal requires a high quality and/or resolution, using the same scalable data stream 18.

According to the invention, the video coder with motion compensated temporal filtering 10 comprises a motion compensated temporal filtering module 100. The motion compensated temporal filtering module 100 converts a group of N images into two groups of images, for example a group of (N+1)/2 low-frequency images and a group of N/2 high-frequency images, and converts these images using a motion estimation made by a motion estimation module 11 of the video coder with motion compensated temporal filtering 10. The motion estimation module 11 performs a motion estimation between each even image denoted x₂[m,n] and the preceding odd image x₁[m,n], or even possibly with the odd image of the following pair, in the image sequence. The motion compensated temporal filtering module 100 compensates the even image x₂[m,n] for motion so that the temporal filtering is as effective as possible. This is because, the smaller the difference between a prediction of the image and the image, the more it will be able to be compressed effectively, that is to say with a good rate/distortion compromise, or, in an equivalent manner, a good ratio of compression ratio to reconstruction quality.

The motion estimation module 11 calculates, for each even and odd pair of images, a motion field, for example and non-limitingly, by a matching of blocks in an odd image to an even image. This technique is known by the term “block matching”. Naturally, other techniques can be used such as for example the technique of motion estimation by meshing. Thus a matching of certain pixels of the even source images is carried out with pixels of the odd image. In the particular case of an estimation by block, the value of the motion of the block can be allocated to each pixel and to each subpixel of the block of the odd image. In a variant, the weighted motion vector of the block and the weighted motion vectors of the neighbour blocks are allocated to each pixel of the block according to the technique known by the term OBMC (Overlapped Block Motion Compensation).

The motion compensated temporal filtering module 100 performs a discrete wavelet decomposition of images in order to decompose the video image sequence into several temporal sub-bands distributed over one or more resolution levels. The discrete wavelet decomposition is applied recursively to the low-frequency sub-bands of the temporal sub-bands as long as the required decomposition level has not been achieved. The decision module 12 of the motion compensated temporal filtering video coder 10 determines whether or not the required decomposition level has been reached.

The various frequency sub-bands obtained by the motion compensated temporal filtering module 100 are transferred to the scalable data stream generating module 13. The motion estimation module 11 transfers the motion estimations to the scalable stream generating module 13, which composes a scalable data stream 18 from the various frequency sub-bands and motion estimations.

FIG. 2 depicts a block diagram of the motion compensated temporal filtering module of the video coder of FIG. 1 when Haar filters are used in the wavelet decomposition. The motion compensated temporal filtering module 100 performs a temporal filtering according to the technique known by the term “lifting”. This technique makes it possible to perform a simple, flexible and perfectly reversible filtering equivalent to a wavelet filtering.

The source even image x₂[m,n] is upsampled by the synthesis module 110 by performing, according to the invention, a discrete wavelet transform synthesis or SDWT. This is because, using a DWT synthesis in place of an interpolation, the difference in prediction is greatly reduced in particular if the image x₂(m,n) is obtained by discrete wavelet decomposition.

The image source is, for the part of the motion compensated temporal filtering module 100 consisting of the modules 110 to 16, the even image x₂[m,n].

The upsampled even image x₂[m,n] is once again upsampled by the interpolation module 111. The interpolation module 111 performs the interpolation so as to obtain an image with a resolution for example of a quarter of a pixel. The interpolation is for example a bilinear interpolation in which the pixels closest to the pixel currently being processed are weighted by coefficients whose sum is equal to one and which have a linear decrease with respect to their distance from the pixel currently being processed. In a variant, the interpolation is a bicubic interpolation or a cardinal sine interpolation. Thus the image denoted x₂[m,n] is transformed by the synthesis module 110 and the interpolation module 111 into an image x′₂[m′,n] having for example a resolution of a quarter of a pixel.

The motion compensated temporal filtering module 100 also comprises an initial motion connection module 121. The initial motion connection module 121 forms an image x′₁[m″,n″] comprising at least four times more pixels than the destination image x₁[m,n]. The image x₁′[m″,n″] is formed by interpolation of x₁[m,n] or by any other method and associates, with each pixel and subpixel of the image x′₁[m″,n″], for example the motion vector of the block estimated by the initial motion connection module 121 comprising these pixels and subpixels. The destination image is, for the part of the motion compensated temporal filtering module 100 consisting of the modules 110 to 116, the odd image x₁[m,n]

Pixel of the image x′₂[m′,n′] means here a pixel of the image x′₂[m′,n′] and that has the same position as a pixel of the image x₂[m,n]. Subpixel of the image x′₂[m′,n′] means here a pixel of the image x′₂[m′,n′] that which was created by a DWT synthesis and/or an interpolation. Pixel of the image x₁[m″,n″] means here a pixel of the image x′₁[m″,n″] that has the same position as a pixel of the image x₁[m,n]. Subpixel of the image x′₁[m″,n″] means here a subpixel of the image x′₁[m″,n″] that was created by a DWT synthesis and/or an interpolation.

The motion compensated temporal filtering module 100 comprises a motion field densification module 112. The motion field densification module 112 associates, with each of the pixels and subpixels of the destination image x′₁[m″,n″] at least one pixel of the source image x′₂[m′,n′] using connections established by the initial motion connection module 121.

When all the associations have been made, the accumulation model 113 creates an accumulation image Xa′[m″,n″] the size of which is the size of the image x′₁[m″,n″]. The value of each of the pixels and subpixels of the accumulation image Xa′[m″,n″] is equal to the sum of the values of the pixels and subpixels of the source image x′₂[m′,n′] associated with the corresponding pixel or subpixel in the destination imagex′₁[m″,n″], this sum being normalized or more precisely divided by the number of pixels and subpixels of the source image x′₂[m′,n′] associated with the corresponding pixels or subpixel in the image x′₁[m″,n″]. This division makes it possible to avoid artefacts, such as pre- and/or post-echo effects, appearing when the image sequence is decoded.

In a variant embodiment of the invention, a weight denoted W_{connex} is allocated to each of the associations. The updating value for each pixel or subpixel of the image Xa′[m′,n′] will be calculated according to the formula:

$$Maj = ( {\sum }_{associations} {W}_{connex} * Valsrc ) / {W}_{connex}$$

in which Maj is the value of a pixel or subpixel of the image Xa′[m″,n″] and Valscr is the value of the pixel of the source image x₂[m,n] associated with the pixel or subpixel of the destination image x′₁[m″,n″].

The image Xa′[m″,n″] is then filtered by a low-pass filter denoted 114. The function of the low-pass filter 114 is to eliminate certain high-frequency components of the image Xa′[m″,n″], so as to avoid any artifact relating to an aliasing of the spectrum during subsampling of the image effected by the unit 115.

By effecting a low-pass filtering on all the pixels and subpixels of the image Xa′[m″,n″], some details of the image Xa′[m″,n″] are preserved.

The filtered image Xa′[m″,n″] is then subsampled by the module 115. The module 115 comprises a first subsampler and a discrete wavelet decomposition module that subsamples the image Xa′[m″,n″] so that the latter has the same resolution as the image x₁[m,n]. The subsampled image Xa′[m″,n″] is then subtracted from the image x₁[m,n] by the subtracter 116 in order to form an image denoted H[m,n] comprising high-frequency components. The image H[m,n] is then transferred to the scalable data stream generation module 13 and to the synthesis module 130.

The source image is, for the part of the motion compensated temporal filtering module 100 consisting of the modules 130 to 136, the image H[m,n].

The source image H[m,n] is upsampled by the synthesis module 130 by performing, according to the invention, a discrete wavelet transform synthesis or SDWT.

The upsampled source image H[m,n] is once again upsampled by the interpolation module 131 in order to obtain a source image H′[m′,n′]. The interpolation module 131 performs the interpolation so as to obtain an image with a resolution for example of a quarter of a pixel. The interpolation is for example an interpolation identical to that performed by the interpolation module 111.

The motion compensated temporal filtering module 100 also comprises a motion field densification module 132.

The motion field densification module 132 reverses the initial connections between x′₁[m″,n″] and x′₂[m′,n′] generated by the initial motion connection module in order to apply them between the source image H′[m′,n′] and the destination image x′₂[m″,n″] The destination image is, for the part of the motion compensated temporal filtering module 100 consisting of the modules 130 to 136, the image x₂[m,n] or x′₂[m″,n″].

The motion field densification module 132 associates with each of the pixels and subpixels of the destination image x′₂[m,n″] at least one pixel of the source image H′[m′,n′] from the connections established by the initial motion connection module 121.

It should be noted here that some pixels and/or subpixels of the destination image x′₂[m″,n″] are not associated with pixels or subpixels of the source image H′[m′,n′]. These pixels or subpixels make the motion field not perfectly reversible and will caused artefacts when the image is reconstructed at the decoder of the client. The motion field densification module 132, according to the invention, establishes associations for these holes. For this purpose, the motion field densification module 132 associates iteratively, and by propagation gradually, with each pixel and subpixel of the destination image x′₂[m″,n″], the pixel of the image source H′[m′,n′] that is associated with the closest adjoining pixel or subpixel, as long as all the pixels and subpixels of the destination image x′₂[m′,n″] do not have at least one pixel or subpixel of the associated source image H′[m′,n′]. It should be noted here that, in a particular embodiment, when a pixel or subpixel of the destination image x′₂[m″,n″] is associated with a predetermined number of pixels of the source image H′[m′,n′], for example with four pixels, no new association is made for the said pixel.

When all the associations have been made, the accumulation module 133 create an accumulation image Xb′[m″,n″]. The accumulation image Xb′[m″,n″] is of the same size as the destination image x′₂[m″,n″] and the value of each of its pixels and subpixels is equal to the sum of the values of the pixels and subpixels of the source image H′[m′,n′] associated with the corresponding pixel or subpixel in the image x′₂[m″,n″], this sum being divided by the number of pixels and subpixels of the image x′₂[m″,n″] associated with the corresponding pixel or subpixel in the source image H′[m′,n′]. This division makes it possible to avoid artefacts, such as pre- and/or post-echo effects, appearing during the decoding of the image sequence.

In a variant embodiment of the invention, a weight denoted W_{connex} is allocated to each of the associations. The update value for each pixel or subpixel of the image Xb′[m″,n″] will be calculated according to the formula:

$$Maj = ( {\sum }_{associations} {W}_{connex} * Valsrc ) / {W}_{connex}$$

in which Maj is the value of a pixel or subpixel of the image Xb′[m″,n″], and Valsrc is the value of the pixel of the source image H′[m′,n′] associated with the pixel or subpixel of the destination image x′₂[m″,n″].

The image Xb′[m″,n″] is then filtered by a low-pass filter denoted 134. The function of the low-pass filter 134 is to eliminate certain high-frequency components of the image Xb′[m″,n″], so as to avoid any artifact relating to spectrum aliasing during the subsampling of the image effected by the unit 135. By performing a low-pass filtering on the all the pixels and subpixels of the image Xb′[m″,n″], some details of the image Xb′[m″,n″], are preserved.

The filtered image Xb′[m″,n″], is then subsampled by the module 115. The module 135 comprises a first subsampler and a discrete wavelet decomposition module that subsamples the image Xb′[m″,n″], so that the latter has the same resolution as the image x₂[m,n]. The subsampled image Xb′[m″,n″], is then half added to the image x₂[m,n] by the adder 136 in order to form an image denoted L[m,n] comprising low-frequency components. The image L[m,n] is then transferred to the scalable data stream generation module 13.

The image L[m,n] is then transferred to the decision module 12 of the motion compensated temporal filtering video coder 10 when the required resolution level is obtained or reprocessed by the motion compensated temporal filtering module 100 for the new decomposition. When a new decomposition must be performed, the image L[m,n] is processed by the motion compensated temporal filtering module 100 in the same way as that previously described.

Thus the motion compensated temporal filtering module 100 forms, for example when Haar filters are used, high- and low-frequency images of the form:
H[m,n]=x₁[m,n]−(W_{2->1}x₂[m,n]
L[m,n]=(x₂[m,n]+½(W_{1->2}H[m,n])
where W_{i→j} denotes the motion compensation of the image i on the image j.

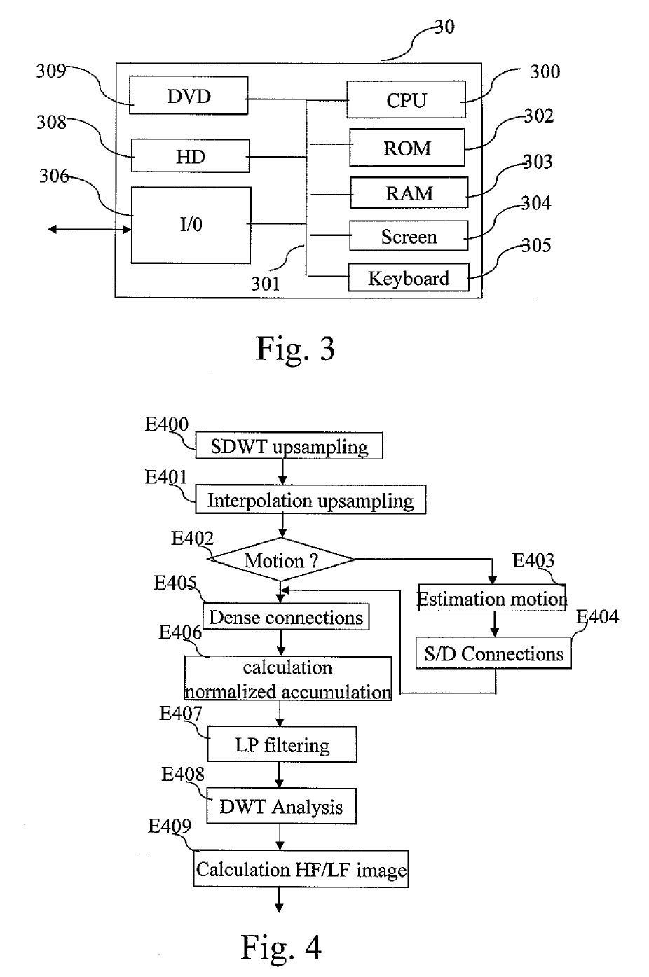

FIG. 3 depicts a block diagram of a computing and/or telecommunication device able to execute the coding and decoding algorithms in accordance with the algorithms described with reference to FIGS. 4 and 8.

This computing and/or telecommunication device 30 is adapted to perform, using software, a motion compensated temporal filtering on an image sequence. The device 30 is also able to perform, using software, an inverse motion compensated temporal filtering on a coded image sequence according to the invention.

The device 30 is for example a microcomputer. It may also be integrated in video image sequence display means such as a television or any other device generating a set of information intended for reception terminals such as televisions, mobile telephones, etc.

The device 30 comprises a communication bus 301 to which there are connected a central unit 300, a read only memory 302, a random access memory 303, a screen 304, a keyboard 305, a hard disk 308, a digital video disk player/recorder or DVD 309, and a communication interface 306 with a telecommunication network.

The hard disk 308 stores the program implementing the invention, as well as the data permitting the coding and/or decoding according to the invention.

In more general terms, the programs according to the present invention are stored in a storage means. This storage means can be read by a computer or a microprocessor 300. This storage means is integrated or not in the device, and may be removable.

When the device 30 is powered up, the programs according to the present invention are transferred into the random access memory 303, which then contains the executable code of the invention as well as the data necessary for implementing the invention.

The communication interface 306 makes it possible to receive a stream of coded scalable data according to the invention for decoding thereof. The communication interface 306 also makes it possible to transfer over a telecommunication network a coded scalable data stream according to the invention.

FIG. 4 depicts the coding algorithms executed by a processor when the motion compensated temporal filtering is executed using software and in which Haar filters are used in the wavelet decomposition.

The processor 300 of the coding and/or decoding device 30 performs a temporal filtering according to the technique known by the term “lifting”.

At step E400, the source image is upsampled by the processor 300 by performing, according to the invention, a discrete wavelet transform synthesis. The source image is, for the present description of the present algorithm, the even image x₂[m,n].

At step E401, the upsampled source image x₂[m,n] is once again upsampled by performing an interpolation. The interpolation is for example a bilinear interpolation or a bicubic interpolation or a cardinal sine interpolation. Thus the image x₂[m,n] is transformed into an image x′₂[m′,n′] having for example a resolution of a quarter of a pixel.

At step E402, it is checked whether a motion estimation has already been made between the even image x₂[m,n] and the destination image x₁[m,n] currently being processed. The destination image is here the odd image x₁[m,n].

If so, the processor 300 reads the motion estimation stored in the RAM memory 303 of the device 30 and moves to step E405. If not, the processor 300 moves to step E403.

At this step, the processor 300 calculates a motion field, for example and non-limitingly, by matching blocks of the source image and of the destination image. Naturally other techniques can be used, for example the technique of motion estimation by meshing.

Once this operation has been performed, the processor 300 moves to the following step E404, which consists of establishing a connection of the initial motions obtained at step E403. The processor 300 associates, with each pixel of the destination image x₁[m,n], or each subpixel of the destination image x′₁[m″,n″] when the destination image is upsampled, for example the motion vector of the block comprising these pixels.

The destination image is, for the present description of the present algorithm, the odd image x₁[m,n].

The processor 300 then at step E405 performs a densification of the connections. This densification is performed in the same way as that performed by the motion field densification module 112.

Once this operation has been performed, the processor 300 creates at step E406 an accumulation image Xa′[m″,n″] in the same way than that performed by the accumulation module 113.

The image Xa′[m″,n″] is then filtered at step E407 by performing a low-pass filtering at step E407 so as to eliminate certain high-frequency components of the image Xa′[m″,n″] and to avoid any artifact relating to spectrum aliasing during the subsequent subsampling of the image.

The filtered image Xa′[m″,n″] is then subsampled at step E408 by performing a subsampling and discrete wavelet decomposition of the image Xa′[m″,n″] so that it has the same resolution as the image x₁[m,n]. The subsampled image Xa′[m″,n″] is then subtracted from the image x₁[m,n] at step E409 in order to form an image denoted H[m,n] comprising high-frequency components. The image H[m,n] is then transferred to the scalable data stream and generation module 13.

The processor 300 once again performs steps E400 to E409, taking as the source image the image H[m,n] and as the destination image the image x₂[m,n].

The processor, at steps E400 and E401, performs the same operations on the image H[m,n] as those performed on the image x₂[m,n]. They will not be described further.

At step E405, the processor 300 effects a densification of the connections in the same way as that performed by the motion field densification module 132 previously described.

When all the associations have been made, the processor 300 creates, at step E406, an image Xb′[m″,n″] in the same way as that described for the accumulation module 133.

At steps E407, E408 the processor 300 performs the same operations on the image X′b[m″,n″] as those performed on the image Xa′[m″,n″], and they will not be described further.

When these operations have been performed, the processor 300 adds half of the filtered and subsampled image X′b[m″,n″] to the image x₂[m,n] in order to form an image L[m,n] of low-frequency components.

The image L[m,n] is then transferred to the decision module 12 of the motion compensated temporal filtering video coder 10 when the required resolution level is obtained or reprocessed by the present algorithm for a new decomposition. When a new decomposition is to be performed, the image L[m,n] is processed in same way as that previously described.

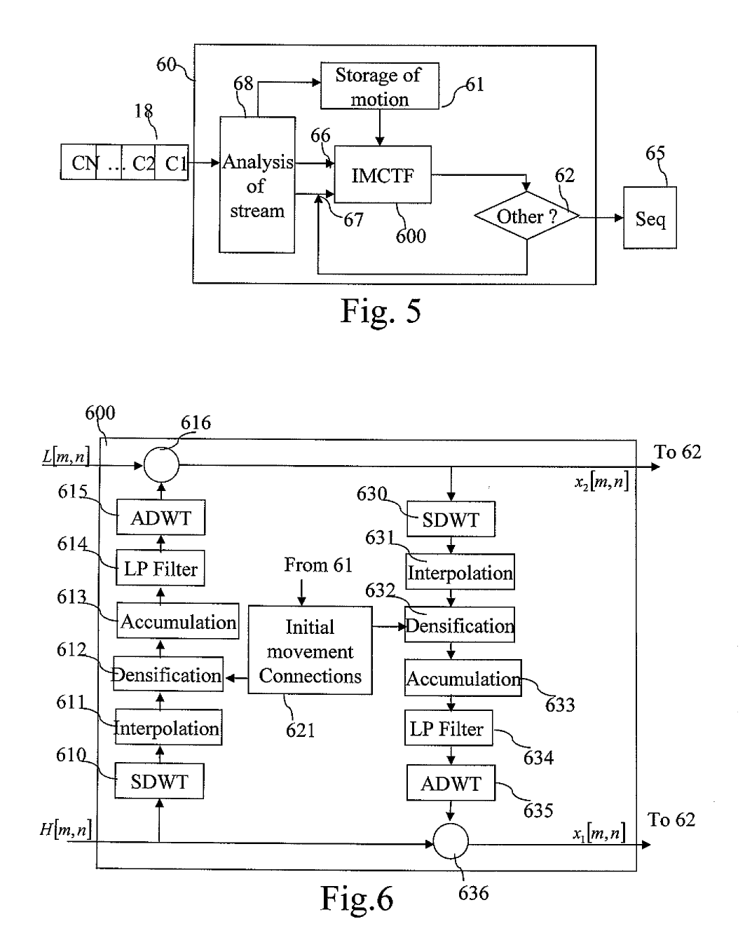

FIG. 5 depicts a block diagram of a motion compensated temporal filtering video decoder according to the invention.

The motion compensated temporal filtering video decoder 60 is able to decode a scalable data stream 18 into a video image sequence 65, the data included in this scalable data stream having been coded by a coder as described in FIG. 1.

The motion compensated temporal filtering video decoder 60 comprises a module 68 for analysing the data stream 18 The analysis module 68 analyses the data stream 18 and extracts therefrom each high-frequency image of each decomposition level as well as the image comprising the low-frequency components of the lowest decomposition level. The analysis module 68 transfers the images comprising the high-frequency components 66 and low-frequency components 67 to the inverse motion compensated temporal filtering module 600. The analysis module 68 also extracts from the data stream 18 the various estimations of the motion fields made by the coder 10 of FIG. 1 and transfers them to the motion field storage module 61.

The inverse motion compensated temporal filtering module 600 iteratively transforms the high-frequency image and the low-frequency image in order to form an even image and an odd image corresponding to the low-frequency image of the higher decomposition level. The inverse motion compensated temporal filtering module 600 forms a video image sequence from the motion estimations stored in the module 61. These motion estimations are estimations between each even image and the following odd image in the video image sequence coded by the coder 10 of the present invention.

The inverse motion compensated temporal filtering module 600 performs a discrete wavelet synthesis of the images L[m,n] and H[m,n] in order to form a video image sequence. The discrete wavelet synthesis is applied recursively to the low-frequency images of the temporal sub-bands as long as the required decomposition level has not been attained. The decision module 62 of the inverse motion compensated temporal filtering video decoder 600 determines whether or not the required decomposition has been attained.

FIG. 6 depicts a block diagram of the inverse motion compensated temporal filtering module of the video decoder at FIG. 5 when Haar filters are used in the wavelet decomposition.

The inverse motion compensated temporal filtering module 600 performs a temporal filtering according to the “lifting” technique so as to reconstruct the various images of the sequence of video images coded by the coder of the present invention.

The image H[m,n] or source image is upsampled by the synthesis module 610. The synthesis module 610 is identical to the synthesis module 130 in FIG. 2 and will not be described further.

The upsampled image H[m,n] is once again upsampled by the interpolation module 611 in order to form an image H′[m′,n′]. The interpolation module 611 is identical to the interpolation module 131 in FIG. 2 and will not be described further.

The motion compensated temporal filtering module 100 also comprises an initial motion connection module 621, identical to the initial motion connection module 121 in FIG. 2, and will not be described further.

The inverse motion compensated temporal filtering module 600 comprises an inverse motion field densification module 612. The inverse motion field densification module 612 is identical to the motion field densification module 132 in FIG. 2 and will not be described further.

The inverse motion compensated temporal filtering module 600 comprises an accumulation module 613 identical to the accumulation module 133 in FIG. 2 and will not be described further. The accumulation module 613 creates an accumulation image Xb′[m″,n″].

The inverse motion compensated temporal filtering module 600 comprises a filtering module 614 and a discrete wavelet decomposition module 615 identical respectively to the filtering module 134 and to the discrete wavelet decomposition module 135, and will not be described further.

The inverse motion compensated temporal filtering module 600 comprises an adder 616 that subtracts half of the filtered and subsampled image Xb′[m″,n″] from the image L[m,n] in order to form an even image denoted x₂[m,n].

The image x₂[m,n] or source image is upsampled by the synthesis module 630. The synthesis module 630 is identical to the synthesis module 610 of FIG. 6 and will not be described further.

The upsampled image x₂[m,n] is once again upsampled by the interpolation module 631 in order to form an image x′₂[m′,n′]. The interpolation module 631 is identical to the interpolation module 111 in FIG. 2 and will not be described further.

The inverse motion compensated temporal filtering module 600 comprises an inverse motion field densification module 632. The inverse motion field densification module 632 is identical to the motion field densification 112 in FIG. 2 and will not be described further.

The inverse motion compensated temporal filtering module 600 comprises an accumulation module 633 identical to the accumulation module 113 in FIG. 2 and will not be described further. The accumulation module 633 creates an accumulation image Xa′[m″,n″].

The inverse motion compensated temporal filtering module 600 comprises a filtering module 634 and a discrete wavelet decomposition module 635 identical respectively to the filtering module 114 and to the discrete wavelet decomposition module 115, and will not be described further.

The inverse motion compensated temporal filtering module 600 comprises an adder 636 that adds the filtered and subsampled image Xa′[m″,n″] to the image H[m,n] in order to form an odd image denoted x₁[m,n]. This odd image is transferred to the decision module 62. The images x₁[m,n] and x₂[m,n] are, according to the required decomposition level, interleaved in order to produce a image L[m,n] reintroduced or not with the higher-level image H[m,n], read in the scalable data stream 18 in the inverse motion compensated temporal filtering module 600.

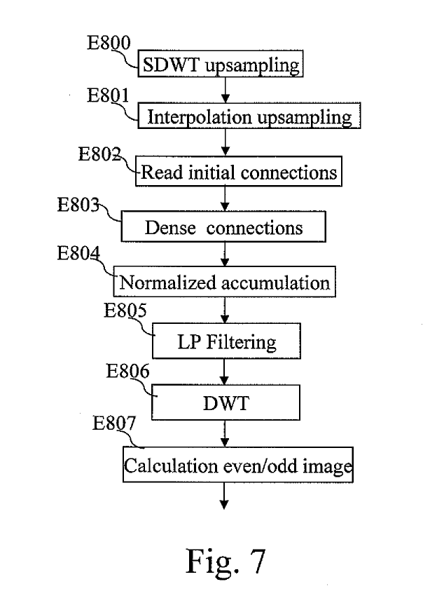

FIG. 7 depicts the decoding algorithm executed by a processor when the inverse motion compensated temporal filtering is executed from software in which Haar filters are used in the wavelet decomposition.

The processor 300 of the coding and/or decoding device 30 performs a temporal filtering according to the technique known by the term “lifting”.

The processor 300 performs the steps E800 to E807 by taking the image H[m,n] as the source image and the image L[m,n] as the destination image.

At step E800, the source image H[m,n] is upsampled by the synthesis module by means of the processor 300, performing according to the invention a SDWT.

At step E801, the upsampled source image H[m,n] is once again upsampled by performing an interpolation in the same way as that described with reference to step E401 in FIG. 4 in order to form an image H′[m′,n′].

At step E802, the processor 300 reads the corresponding motion field in the scalable date stream 18 and establishes the initial connections. This step is identical to step E404 in FIG. 4 and will not be described further.

Once this operation has been performed, the processor 300 passes to the following step E803 and establishes dense connections. The processor 300 associates, with each of the pixels and subpixels of the source image H′[m′,n′], at least one pixel of the destination image L[m,n] using connections established by the initial motion connection module 621. The dense connections are established between the pixels and subpixels of the source and destination images in the same way as that carried out by the densification module 132 in FIG. 2.

When all the associations have been made, the processor 300 moves to step E804 and creates an accumulation image Xb′[m″,n″]. The accumulation image Xb′[m″,n″] is created in the say way as that described for the accumulation module 133 in FIG. 2 and will not be described further.

The image Xb′[m″,n″] is then filtered at step E805 by performing a low-pass filtering so as to eliminate certain high-frequency components of the image Xb′[m″,n″] and to avoid any artefacts related to spectrum aliasing during the subsequent subsampling of the image.

The filtered image Xb′[m″, n″] is then subsampled at step E806 by performing a subsampling and then a discrete wavelet decomposition of the image Xb′[m″,n″] so that the latter has the same resolution as the image L[m,n].

The subsampled image Xb′[m″,n″] is then half subtracted from the image L[m,n] at step E807 in order to form an image denoted x₂[m,n]. The processor 300 once again performs steps E800 to E807, taking the image x₂[m,n] as the source image and the image H[m,n] as the destination image.

At steps E800 to E802 the processor performs the same operations on the source image x₂[m,n] as those performed previously on the source image H[m,n], and will not be described further.

At step E803 the processor 300 carries out a densification of the connections in the same way as that carried out by the motion field densification module 112 previously described.

When all the associations have been made, the processor 300 creates, at step E804, an image Xa′[m″,n″] in the same way as that described for the accumulation module 113.

At steps E805 and E806 the processor 300 performs the same operations on the image X′a[m″,n″] as those performed on the image Xb″[m″,n″] and will not be described further.

When these operations have been performed, the processor 300 adds the filtered and subsampled image X′a[m″,n″] to the image H[m,n] in order to form an odd image x₁[m,n]. The images x₁[m,n] and x₂[m,n] are, according to the required decomposition level, reintroduced or not into the inverse motion compensated temporal filtering module 600.

The present invention is presented in the context of a use of Haar filters. Other filters, such as the filters known by the term 5/3 filters of 9/7 filters, are also used in the present invention. These filters use a larger number of source images in order to predict a destination image.

These filters are described in the document by M B Adams “Reversible wavelet transform and the application to embedded image compression”, MASC thesis, Department of Electrical and Computer Engineering, University of Victoria BC 1998.

Conventionally, the modules 110 to 116 of the motion compensated temporal filtering module of the video coder are modules for predicting a destination image, whilst the modules 130 to 136 of the motion compensated temporal filtering module of the video coder are modules for updating a destination image. The modules 610 to 616 of the inverse motion compensated temporal filtering module are modules for updating a destination image whilst the modules 630 to 636 of the motion compensated temporal filtering module of the video coder are modules for predicting a destination image.

The coding and decoding devices as described in the present invention form, for each pair consisting of a source image and the destination image, an accumulation image in accordance with what was presented previously. Each of these accumulation images is taken into account for the prediction and/or updating of the destination image.

The accumulation image thus formed is then added to or subtracted from the destination image.

Naturally the present invention is in no way limited to the embodiments described here, but quite the contrary encompasses any variant with the capability of a person skilled in the art.

1. Method of coding a video image sequence by motion compensated temporal filtering using discrete wavelet decomposition, the discrete wavelet decomposition comprising dividing the video image sequence into source and destination groups of images, with at least one step of determining, from at least one image including pixels the groups of the source group, an image representing an image in the destination group, the representative image including pixels and subpixels determined from pixels and subpixels obtained by upsampling at least one image in the source group.

2. Method according to claim 1, wherein the images in the source group are upsampled by performing at least one wavelet decomposition synthesis.

3. Method according to claim 1, further including:
determining a motion field between the image in the destination group and each image in the image source group used for determining the image;
associating, from the determined motion field, at least one pixel and/or subpixel of each image in the source group used for predicting the image, with each pixel and each subpixel of the image representing the image in the destination group.

4. Method according to claim 3, wherein the value of each pixel and each subpixel of the image representing the image in the destination group is obtained by summing the value of each pixel and subpixel associated with said pixel and subpixel of the image representing the image in the destination group and by dividing the sum by the number of pixels and subpixels associated with said pixel or said subpixel of the image representing the image in the destination group.

5. Method according to claim 1, further including low pass filtering the image representing the image in the destination group.

6. Method according to claim 5, wherein the image representing the image in the destination group is subsampled by at least one discrete wavelet decomposition to obtain a subsampled image having the same resolution as the image in the destination image group that it represents.

7. Method of decoding a video image sequence by motion compensated temporal filtering using discrete wavelet decomposition, the discrete wavelet decomposition comprising dividing the video image sequence into source and destination groups of images, at least one step of determining, from at least one image including pixels in the source group, an image representing an image in the destination group, the representative image including pixels and subpixels determined from pixels and subpixels obtained by upsampling at least one image in the source group.

8. Method according to claim 7, wherein the images in the source group are upsampled by performing at least one wavelet decomposition synthesis.

9. Method according to claim 7, further including:
determining a motion field between the image in the source group and each image in the destination group of images used for determining the image;
associating, from the determined motion field, at least one pixel and/or subpixel of each image in the source group used for predicting the image, with each pixel and each subpixel of the image representing the image in the destination group.

10. Method according to claim 9, wherein the value of each pixel and each subpixel of the image representing the image in the destination group is obtained by adding the value of each pixel and subpixel associated with said pixel and subpixel of the image representing the image in the destination group and by dividing the sum by the number of pixels and subpixels associated with said pixel or said subpixel of the image representing the image in the destination group.

11. Method according to claim 7, further including low pass filtering the image representing the image in the destination group.

12. Method according to claim 11, wherein the image representing the image in the destination group is subsampled by a discrete wavelet decomposition in order to obtain a subsampled image with the same resolution as the image in the destination group of images that it represents.

13. Device for coding a video image sequence by motion compensated temporal filtering using discrete wavelet decomposition, the device comprising a discrete wavelet decomposition arrangement comprising a processor arrangement for: (a) dividing the video image sequence into source and destination groups of images, (b) determining, from at least one image including pixels of the source group, an image representing an image in the destination group, and (c) forming the representative image so it includes pixels and subpixels determined from pixels and subpixels obtained by upsampling at least one image in the source group.

14. Device for decoding a video image sequence by motion compensated temporal filtering using discrete wavelet decomposition, the device comprising a discrete wavelet decomposition means arrangement comprising a processor arrangement for: (a) dividing the video image sequence into source and destination groups of images, (b) determining, from at least one image including pixels the source group, an image representing an image in the destination group, and (c) for forming the representative image so it includes pixels and subpixels determined from pixels and subpixels obtained by upsampling at least one image in the source group.

15. An information or memory device including computer readable code storing a computer program including instructions for causing a computer system to perform the method of claim 1.

16. An information or memory device including computer readable code storing a computer program including instructions for causing the computer to perform the method of claim 7.

17. Signal comprising a video image sequence coded by motion compensated temporal filtering using discrete wavelet decomposition, the signal comprising high- and low-frequency images obtained by dividing the video image sequence into source and destination groups of images and determining, from at least one image including pixels of one the source group, an image representing an image in the destination group, wherein high- and low-frequency images are obtained from pixels and subpixels determined from pixels and subpixels obtained by upsampling at least one image in the source group.

18. Method of transmitting a signal comprising a video image sequence coded by motion compensated temporal filtering using discrete wavelet decomposition, the signal comprising high- and low-frequency images obtained by dividing the video image sequence into source and destination groups of images and determining, from at least one image including pixels of one of the source group, an image representing an image in the destination group, and wherein the high- and low-frequency images are obtained from pixels and subpixels determined from pixels and subpixels obtained by upsampling at least one image in the source group.

19. Method of storing a signal comprising a video image sequence coded by motion compensated temporal filtering using discrete wavelet decomposition, the signal comprising high- and low-frequency images obtained by dividing the video image sequence into two groups of images and determining, from at least one image composed of pixels in one of the groups of images called the source group, an image representing an image in the other group of images called the destination group, and in which the high- and low-frequency images are obtained from pixels and subpixels determined from pixels or subpixels obtained by upsampling at least one image in the source group.
